(19) United States
(12) Patent Application Publication
(10) Pub. No.: US 2007/0220041 A1
(43) Pub. Date: Sep. 20, 2007

(54) Prior Art Notes Associated with Patent Applications

(75) Inventors: Andrew S. Van Luchene, Santa Fe, NM (US); Raymond J. Mueller, Palm Beach Gardens, FL (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/690,095

(22) Filed: Mar. 22, 2007

Related U.S. Application Data
(63) Continuation-in-part of application No. 11/611,024, filed on Dec. 14, 2006.
Application No. 11/611,024 is a continuation-in-part of application No. 11/462,621, filed on Aug. 4, 2006.
(60) Provisional application No. 60/727,191, filed on Oct. 14, 2005.

(51) Int. Cl. G06F 7/00

(52) U.S. Cl. 707/102

(57) ABSTRACT

Improved methods for drafting, preparing, submitting and examining a patent application are described. The system incorporates a web-based tool in which applications are drafted. The web-based tool allows further allows for the submission, association, and display of notes regarding applications. The notes may be text or hyperlinks to prior art references. The relevance of the prior art documents to the patent application may be indicated by visible indicia.

### BACKGROUND

Protecting intellectual property through patent systems is a vital part of most country's national economies and well as the international economy. However, many known patent systems suffer from a number of disadvantages. Examples of the disadvantages of current patenting systems include: patents being issued by the patent office are of poor quality; patents take too long to be issued, compared to the demand of applicants; inventors being unable to easily search patents to locate relevant prior art; attorneys with little or no incentive to clearly identify, in a patent application they prepare, the invention being patented; and potential patent licensees lacking an easy method to determine the strength of a patent. Accordingly, it would be advantageous to provide improved methods and apparatus for examining and granting protection to intellectual property.

### BACKGROUND

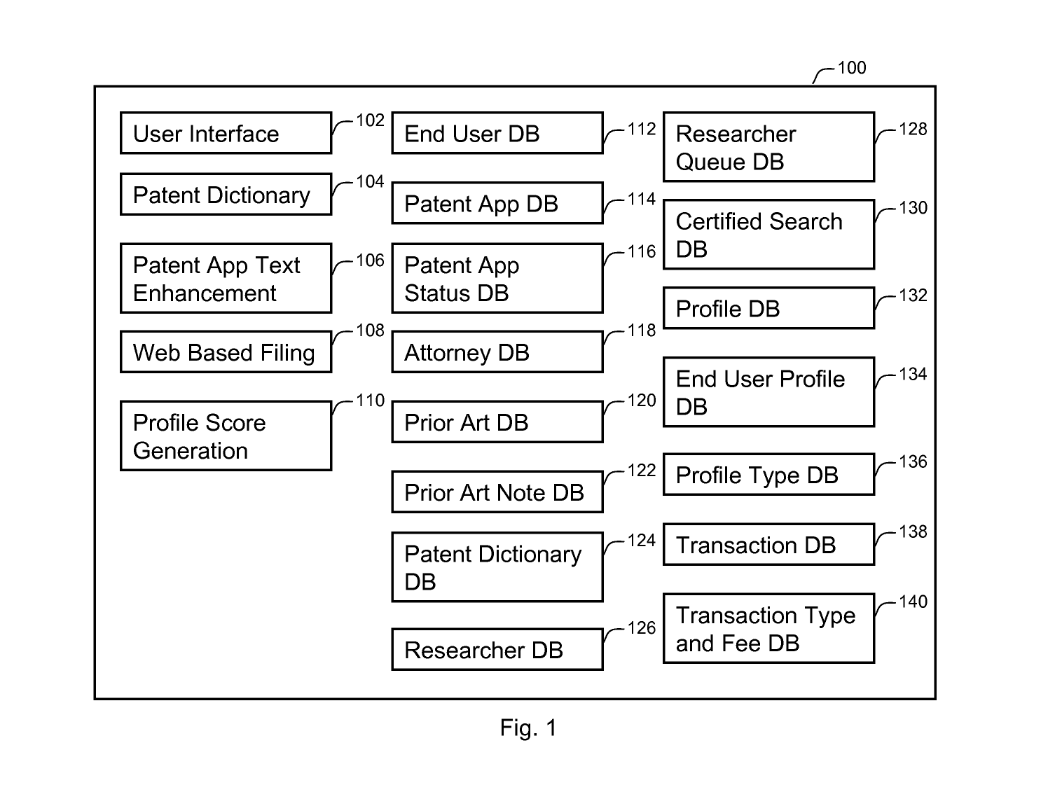

FIG. 1 is a block diagram of a system 100 according to an exemplary embodiment of the present disclosure.

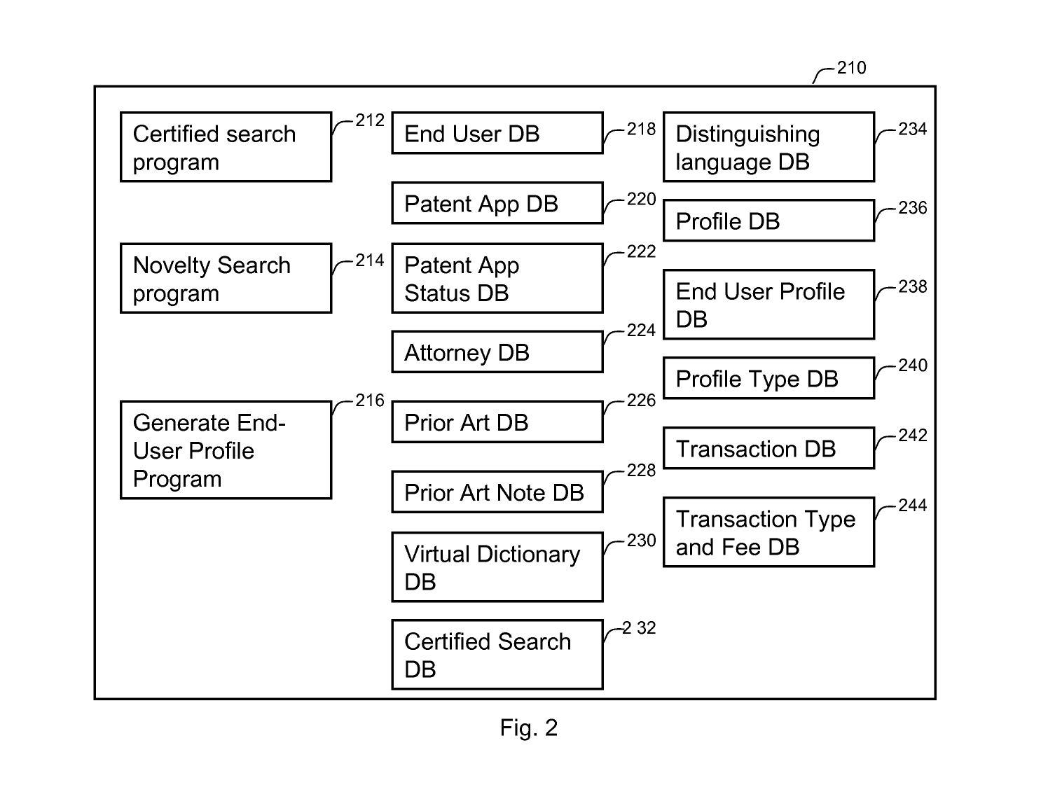

FIG. 2 is a block diagram of a system 200 according to an exemplary embodiment of the present disclosure.

### DETAILED DESCRIPTION

Definitions:

Abstract of the Invention—includes that part of a patent application that is the abstract as defined by the USPTO guidelines

Agent—includes the agent responsible for filing a patent application

Alternate Language—includes words that can be used as alternates for words in a patent application

Artificial Intelligence—includes any computer program that uses neural nets and genetic algorithms.

Assignee Name—includes the meaning defined by the USPTO guidelines

Assignee City—includes the meaning defined by the USPTO guidelines

Assignee State—includes the meaning defined by the USPTO guidelines

Assignee Country—includes the meaning defined by the USPTO guidelines

Attorney—includes the attorney responsible for drafting and/or filing a patent application.

Attorney Name—includes the meaning defined by the USPTO guidelines

Attorney Address—includes the meaning defined by the USPTO guidelines

Attorney State—includes the meaning defined by the USPTO guidelines

Attorney Country—includes the meaning defined by the USPTO guidelines

Background of the Invention—includes that part of a patent application that is background as defined by the USPTO guidelines

Claims—includes that part of a patent application that is claims as defined by the USPTO guidelines

Date Stamp—Includes an electronic, unalterable stamp on an electronic file indicated the date that the file was created or received by a computer system.

Date of Invention—includes the date a patent application has with a first time stamp

Degree of infringement—includes the statistically measured amount that a product or technical white paper infringes an issued patent application

Description of the Invention—includes that part of a patent application that is description as defined by the USPTO guidelines

Draftsperson—includes the meaning defined by the USPTO guidelines

Dollar Value—includes a dollar amount that is defined as the value of a patent license of a patent

End User—includes any user of a system including an inventor, researcher, patent examiner, attorney, or agent who interacts with the system, e.g., by creating, enhancing, researching, filing, prosecuting, licensing, or invalidating, a patent application. An end user may be required to be a member of a central system. An end user may further be a group of inventors, consortium, corporation, or other entity capable of interacting with the system.

Electronic notification—includes an email or other means of digitally sending a message with a date and time stamp to an electronic address.

Errors and Omissions—includes the meaning defined by the USPTO guidelines

Examiner—includes a patent examiner

Issued Patent—includes the meaning defined by the USPTO guidelines

Filing Date—shall be the time stamp of the date that a patent application was submitted to the patent office.

Filed Patent—includes a patent application that is filed with the USPTO

File Wrapper—Includes all files associated with a patent application including but not limited to: the patent application, a certified search, notes of distinguishing language, notes of rejection, notes of additional distinguishing language, record of interview, additional prior art references, and all electronic notifications associated with a patent application.

First Office Action—includes the meaning described in the USPTO guidelines.

Genetic Algorithm—includes a computer algorithm that is capable of modifying and improving itself over time.

Hyperlink—includes a reference or navigation element in a document to another section of the same document, another document, or a specified section of another document, that automatically brings the referred information to the user when the navigation element is selected by the user. As such a hyperlink may be similar to a citation in literature, but with the distinction of automatic instant access. Combined with a data network and suitable access protocol, a hyperlink may instruct a computer to fetch the resource referenced. Hyperlinks are not limited to HTML or the web. Hyperlinks may be used in almost any electronic media.

Infringement—includes that a product or technical white paper practices the invention protected by the claims of an issued patent.

Interview—includes an electronically recorded conversation between an end user and a patent examiner.

Invention Class—includes the meaning described in the USPTO guidelines

Invention Subclass—includes the meaning described in the USPTO guidelines

Invention Figures—includes the meaning described in the USPTO guidelines

Invention Claims—includes the meaning described in the USPTO guidelines

Inventor Name—includes the meaning described in the USPTO guidelines

Inventor City—includes the meaning described in the USPTO guidelines

Inventor State—includes the meaning described in the USPTO guidelines

Inventor Country—includes the meaning described in the USPTO guidelines

Issued Patent—includes the meaning described in the USPTO guidelines

Literature Prior Art—shall be prior art for a patent application other than patents

Missing Parts—includes the meaning described in the USPTO guidelines

Non-Obviousness Score—includes a score given to a patent application by a central system that relates the obviousness of the invention disclosed by the patent application to prior art cited by the central system.

Notice of allowance—includes the meaning defined by the USPTO guidelines

Notes—includes any language added to a prior art record by an end user

Note of distinguishing language—includes notes provided by end users in response to the prior art cited in a certified search. These notes distinguish a patent application submitted by the end user over the prior art references contained in the certified search provided by the central system.

Note of additional distinguishing language—includes notes provided by end users in response to a second office action conducted by a patent examiner.

Note of rejection-shall be the notes contained in a second office action provided by a patent examiner

Novel—includes the meaning described in the USPTO guidelines

Novelty Score—includes a score given to a patent application by a central system that related the novelty of the invention disclosed in the patent application to prior art cited by the central system

Obvious—includes the meaning described in the USPTO guidelines

Office Action—includes the meaning described in the USPTO guidelines

Online Chat Room—includes any electronic correspondence medium that allows for a real time, electronic conversation between a patent examiner and an end user.

Patent Application—Includes any document created to describe and invention by an end user

Patent Application Data—Includes data contained in a patent application

Patent Application Date—includes the time stamped date that a patent application was entered into a central system

Patent Examiner—includes a person responsible for reviewing the patent application and deciding if the patent can be issued.

Patent examination queue—shall be the queue of patent applications that are assigned to a patent examiner that require office actions or reexaminations.

Patent invalidator—includes an end user who is attempting to invalidate an issued patent

Patent License—includes a legal right to use an invention disclosed in an issued patent

Patent Licensee—includes an end user who is licensing an issued patent

Patent Office-Includes the United State Patent and Trademark Office (what about the rest of the world?)

Patent Practitioner or Practitioner—includes an attorney, agent, or inventor responsible for preparation, submission, and/or prosecution of a patent application.

Patent Prior Art—includes prior art that is filed and issued patents

Patent Value score—includes a score assigned by an artificial intelligence system that demonstrates the strength of the claims of an issued patent in light of prior art.

PCT Information—includes the meaning described in the USPTO guidelines

Potential Licensee—includes an end user who may want to license an issued patent

Prior Art—includes any document with a time stamp prior to the time stamp of a patent application

Prior Art Data—Includes data that is prior art

Priority Date—includes the meaning described in the USPTO guidelines

Product—includes a created thing that can be protected by or that can infringe the claims of an issued patent

Published Prior Art—includes prior art that is available for review by the general public

Reexamination—includes a second examination of a patent after it has been issued.

Relevance Score—includes a score assigned by an end user or by a central system to a particular piece of prior art as it relates to a particular patent application.

Research Report—includes a report assemble by a researcher or a central system that contains prior art related to a patent application.

Researcher—includes a person who manually researches prior art databases to find prior art related to a patent application.

Score—includes a numerical value assigned to something as it relates to something else.

Second Office Action—includes the meaning described in the USPTO guidelines

Second examination—includes reexamination

Status Change—includes a change in status of a patent application as it moves through the patent process. Changes in status can include but are not limited submitting the application for examination, receiving a certified search for the application, placing the patent application in an examiner queue, receiving an office action for the patent application, receiving a notice of allowance for the patent application, receiving a notice of missing parts for the patent application; receiving a patent number for the patent application, and receiving an indication of interest from a potential licensee for the patent application.

Submitted Patent Application—includes a patent application that an end user submits to the central system for examination.

Subsequent Patent Application—includes an application that comes after a patent application.

Technical white paper—includes a text description of a product that describes the parts of the product and how they work together.

Time Stamp—includes an unalterable recording of the time a document was created by, entered into, or received by a system.

Title—includes the meaning described in the USPTO guidelines

Web-Based Application—includes an application that is accessible on the World Wide Web via a web browser such as Microsoft's Internet Explorer. The application will be stored on a central server and accessed via other computers.

Web-Based Form—includes an electronic form used to enter information by and end user into a web-based application

Unpublished Prior Art—includes prior art that is not available to the general public, but that can be viewed by employees of the central system.

Useful—includes the meaning described in the USPTO guidelines

Usefulness Score—includes a score given to a patent application based on its usefulness as defined by the USPTO guidelines.

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a “step” or “steps” of a process has sufficient antecedent basis.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3 G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

It will be appreciated that improved intellectual property examination-related systems would be of great use to a wide variety of intellectual property offices throughout the world, whether public, private, or government owned. Furthermore, with the growth of online virtual environments and game in which players are allowed to create items and express their ideas, various mechanisms for dealing with intellectual property generated in virtual space are similarly desirable. Accordingly, it should be understood that the various systems and methods described herein should be considered to be equally applicable to both real world and virtual world environments and applications.

According to one or more embodiments, the present invention provides an automated web-based patent application preparation and submission tool. In one embodiment, an end user can draft a patent application using an online tool. Once the patent application or portion thereof is created, the document can be submitted to: (i) a researcher for further research, (ii) a patent attorney for further drafting, or (iii) the patent office.

According to an embodiment, an end user may enter a description of the invention into a web-based form (e.g., an HTML form with appropriate fields, menus, check boxes or other user interface elements that permit the entry of information). The end user can enter additional information such as:
1. Title
2. Abstract
3. Description/Specification
4. Invention Class and Sub Class
5. Inventor Name
6. Inventor City
7. Inventor State
8. Inventor Country
9. Attorney or Agent
10. PCT Information
11. Date of Invention
12. Background of the Invention
13. Invention Figures
14. Assignee Name
15. Assignee City
16. Assignee State
17. Assignee Country
18. Claims
19. Notes

The information submitted into the tool may be analyzed automatically and/or in real or near real time by the system in order to perform various functions. For example, based on the information submitted, the system can recommend alternate language for sections or draft missing parts of the total patent application. For the purposes of the present disclosure, information is considered to be analyzed automatically any time it is analyzed by the system with the system having to receive additional input, such as a request or command, from the user. It will be appreciated, that computer implemented systems are subject to various operating constraints, such as server loads, processing speeds, and the like, with which those of skill in the art will be familiar and, accordingly, “real time” analysis may not necessarily be instantaneous, but is rather intended to mean that results are automatically provided to the user as soon as they are available, given the various system operating constraints.

Recommendations for alternate language or missing portions may be based on patent applications or other non-copyright protected publications describing similar inventions. For example, the system may use a genetic algorithm to determine like patent applications as the end user is entering the description of his invention. Because patent practitioners often act as their own lexicographers and coin new terminology to describe inventions, such new terminology can be shared immediately and made available to other patent practitioners. In this manner, the system can act as an ever changing virtual dictionary of language for new patent applications. An example of a genetic algorithm that can perform this function is the Semetric program offered by Engenium.

As another example, the system can perform real time prior art search based on the disclosure as the end user types words into the tool. The system could be configured to dynamically display the most relevant prior art choices based on the words and letters being typed and/or synonyms or other words that may be determined as relevant to the search words or terms. The prior art being displayed could then change in real time as the end user types in more words to describe the invention. It will be appreciated that such real time searching could be used for any type of searching and not just searching for prior art for inventions.

Suggestions for alternate language and missing portions or prior art or other searches need not necessarily be performed in real time, but may also or alternatively be performed after a disclosure is submitted by the end user, for example in order to receive an initial review prior to filing, or only upon the end user's request.

According to another embodiment, the system may utilize a genetic algorithm to specify a class and subclass for a patent application. The system may analyze an application in real time, or after it has been submitted, and determine the appropriate class and subclass. The genetic algorithm may or may not allow for the incorporation of classification data from previously submitted applications which are identified by the system or the end user as being similar to the current application.

According to another embodiment, the system may track and/or identify information that is missing from the patent application that is required for filing the patent application with the patent office. The end user can review missing parts for a particular patent application and fill them in as desired. The end user can also leave missing information fields open for subsequent completion, for example, by researchers and/or patent practitioners.

According to another embodiment, one or more notes could be submitted by an end user or other individual in connection with a document, including, for example, an application as it is being drafted, a submitted or filed application, a patent publication, an issued patent, a non-patent reference, an office action, a examiner or practitioner communication, a judicial or review-board decision, or the like. These notes may or may not be viewable to other users and may or may not be used by the system for any suitable purpose, including, for example, preparation or examination of the present application, preparation or examination of other applications, system maintenance, and the collection and dissemination of statistical information. Moreover, notes may or may not be submitted in response to additions, suggestions, or notes from the system or other individuals. Any suitable type of file, including, but not limited to a jpg, digital video, recording, voice message, or textual document could be added to or associated with a document as a note.

As a non-limiting example, an end user may add notes to the alternate language and missing portion suggestions provided to or by the system. These notes can be used by the genetic algorithm to generate improved alternate language and missing portion suggestions for later invention submissions by the same and/or other end users. Moreover, these notes could be readable by subsequent end users and could be used to assist in the drafting of later patent applications.

According to another embodiment, the present disclosure provides for a system in which a practitioner can elect from between multiple post-drafting processing options. The system may or may not require that the application have been drafted using a web-based drafting tool such as that described above. According to this embodiment, once an end user has completed drafting a patent application, the end-user can select whether he wants to:
1. Submit the patent application to a researcher
2. Submit the patent application to an attorney for further drafting
3. Submit the patent application to the Patent Office for filing

In an alternate embodiment, the system can recommend one of the previous three choices to an end user based on the current status of an application. According to this embodiment, the system analyzes the patent application document and compares it to previously filed patent applications. The patent application is scored and the system determines whether the application should be sent to a researcher, an attorney, or to the patent office.

If the end user elects to submit the patent application to a researcher, the system can select or suggest an optimal researcher from its database of researchers based on inventions researched by those researchers and the relevance of those inventions to the invention currently being submitted by the end user. Alternatively or additionally, the system could select or suggest a researcher based on whether a particular researcher has capacity to conduct research on the patent application. If the end user is allowed to select a researcher, a list of applicable researchers could be provided to the user by the system. The list could be sorted or sortable based on relevancy, expected timeframe for research completion, cost, location, or other factors.

As a further embodiment, if the end user is allowed to select a researcher, researchers could bid on the opportunity to research the patent application. Bids could include any number of relevant factors including but not limited to, cost for research, type of fee rate (i.e. flat fee, hourly, etc.), type and extent of results provided, and timeframe for returning results.

Moreover, the system could be configured to provide to the end user contact and qualifications information for each selected or suggested researcher. The end user could then contact the selected or suggested researcher via the system interface and submit the patent application to the researcher for review. A contract can be set up, i.e., drafted and executed automatically, between the end user and the patent researcher using the system.

According to an embodiment, the researcher receives the patent application, creates a research report, and submits the research report to the end user. The research report may be submitted to the end user via the central system. According to some embodiments, the end user can review the prior art cited in the research report and rate its relevance to the invention disclosed. The relevance rankings can be used to match that researcher to subsequent patent applications. The end user can also submit notes distinguishing the application over the prior art cited and/or alter the application, such as to include distinguishing language.

According to an embodiment, the system may be configured to facilitate fee transactions between the end user and the researcher. The system may or may not impose a surcharge for facilitating the fee transactions. For example, once an application has been submitted to a researcher, the system may charge the researcher with a finder's fee. The system could also charge the end user with a researcher finder fee, or, the two parties could split a single fee. Alternatively the system could charge the researcher, who, in turn could charge the end user some, or all, of the fee amount. Alternatively or additionally, once the report has been received by the end user, a research report fee can be charged to the end user and some or all of the fee can be remitted to the researcher.

Alternatively or additionally, the system may be configured to submit the application to an automated searching program configured to produce search results using, for example, a genetic algorithm search program. A genetic algorithm search program is described, for example, previously incorporated U.S. patent application Ser. No. 11/462/621, and U.S. Provisional Patent Application Ser. No. 60/727,191.

If the end user elects to submit the patent application to an attorney (or agent) for additional drafting, the system can determine an optimal attorney from its database of attorneys. The determination may be based on any number of factors including, for example, estimated fee, past applications filed by the attorney, attorney's capacity, attorney qualifications, estimated turn-around, etc. For example, the system may be configured to identify past inventions/applications filed and prosecuted by attorneys in the database and further determine the relevance of those inventions to the invention currently being submitted by the end user.

Moreover, attorneys may be asked or required to provide the system with information regarding their fees for preparation including billing rates and fees for past applications, current availability, estimated turn-around time, past quantity or quality, contact information, etc. Accordingly, the system can select or suggest an attorney based on such information. For example, a given attorney may be selected or suggested based on whether or not the system determines that attorney has capacity to assist the inventor in enhancing the application. Once one or more attorneys are selected by the system or the end user, the system can provide the attorneys' contact information to the end user using any suitable method. According to one embodiment, the end user may receive an attorney's contact information via the web-based form.

Furthermore, the end user may be able to automatically submit the patent application to the attorney via the web-based service. The attorney may then review the application for further refinement. Changes, additions, and alterations made by the attorney may be tracked by the system. Once the attorney has completed the application, the end user may be able to log in or otherwise access the completed application via the system to order to review and approve changes made by the attorney to the application.

If the end-user is not completely or is only partially satisfied with the changes made by the first attorney, and/or if the end-user desires a second opinion or review, the application, with or without the first attorney's changes, may be submitted to a second attorney and such process repeated until the end-user is satisfied with the application. Once final approval is received from the end-user, the patent application can be submitted to the patent office by the system.

The determination of an appropriate attorney may be made at any applicable time, including; for example, at the time the end user opts to submit the draft application to an attorney or while the end user is drafting the application. Moreover, rather than waiting until the end user believes he has “finished” the application; the end user may be able to contact the attorney via the system while drafting the application. For example, while the end user is entering the patent application data into the system, the system can determine an appropriate attorney and offer the opportunity to provide the end user with real time chat with the attorney. If the end user accepts, a chat window is opened between the end user and attorney via the central system. The end user can provide patent application data and the attorney can add and edit the data. When the session is complete, the system can charge a fee to the end user and submit a portion of that fee to the attorney. The recorded chat session is attached to the patent application file.

The system may be configured to facilitate fee transactions and contract formation between the attorney and the end-user. The system may or may not impose a surcharge for such facilitation. For example, when an end user contacts an attorney, a finder's fee can be charged to both the attorney and the end user. Furthermore the system may facilitate with the drafting and execution of a contract between the end user and attorney specifying terms and conditions so that the attorney can complete the application. The system may or may not utilize a standard contract which may or may not be modifiable by the end user and/or the attorney. Once the attorney's changes are made, the system may be configured to charge the fee specified by the contract to the end user for enhancing the patent application and submit some or all of the fee to the attorney.

Once the end user elects to submit the patent application to the patent office, the system may be configured to determine if all information fields have been completed and are accurate/valid. Once the system has determined that all information fields have been completed and tested for accuracy, the system generates the appropriate forms, and submits the patent application, along with the appropriate forms to the patent office. An electronic receipt confirmation is received from the patent office and stored by the central system as well as being transmitted to the end user. The central system charges a filing fee to the end user and remits a portion of that fee to the patent office. If all fields have not been completed, the system steps the applicant through each open field, providing examples and information about each field, its use, etc.

According to a further embodiment, the system may be configured to time and date stamp the patent application file as additions are made by the various parties who can access it. Moreover, the system could time and date stamp and store all files and/or any changes or revisions to such files that are transmitted or entered into the system and so that a record of the invention is maintained.

According to yet another embodiment, the end user may be allowed to determine whether or not an application filed with the system is to be treated as public or private data. If the filed application is to be treated as public data, and thus useful as prior art against other inventions, the end user may further be allowed to identify the application as an invention registration rather than as an application. Just like a filed patent application, an invention registration can be assigned a filing date and used as prior art against later filed applications, but may not be subjected to further examination.

An end user preparing a patent application may desire to get into contact with other end users that are preparing or have prepared other similar or otherwise useful patent applications. Accordingly, the system of the present disclosure may be configured to facilitate communication between end users who are or have worked on similar patent applications. According to this embodiment, when the system receives patent application data from an end user, the system may perform a search to find other end users that are working or have worked on similar patent applications and allow the end users to communicate with one another. Such communication may or may not be anonymous. According to one example, the system receives patent application data from an end user and then uses that patent application data to search against other end user profiles in the system. The system generates a list of end user profiles that are relevant to the patent application data and scores them based on relevance. The system then outputs the list of relevant end users to the end user submitting the patent application data. According to some embodiments, end users may be able to opt in to or out of being a member of this service.

The system may require the use of a user ID and password associated with a specific log in profile or other mechanism to protect privacy and ensure that end users are accessing only the information they are entitled to access. For example, a given user may only be given access to or receive help from applications written by himself, other members of his firm or corporation, other applications for the same inventor or assignee, or other practitioners who have opted in to a program. In cases where an end user is an entity with multiple individuals who access the system, each individual may have the same or a separate log in profile.

In addition to a formal web browser interface, the system may incorporate a smaller or custom designed interface, like a toolbar on a browser or a freestanding toolbar/text field that floats, and/or is hidden but present as an icon (e.g., in the bottom right hand corner in Windows XP). For example, a text field may be ever present on the screen. A user may be able to type a patent number, application number, attorney docket number, etc (along with any necessary password, confirmation number or the like), hit enter and be automatically directed to a search results screen, draft history screen, prosecution history screen, or some other desirable location. Access to such text field may be provided via any other applicable means, including, for example, use of function or other specialized keystrokes that cause such text field or other interface to appear on the end user's display.

In a further embodiment, the system may be configured to make new matter added as part of a continuation in part (CIP) or other application easily identifiable. For example, new matter could be red-lined, highlighted, or otherwise identified by altering the font type, style, size or color and/or in some other recognizable manner as the application is being prepared, or at the time of submission or filing and/or any combination of the forgoing.

Furthermore, any of the processes described herein, such as generation of suggested language, suggested researchers, and suggested attorneys could be performed for the new material. As a further embodiment, a new search request or automated research report could be automatically generated for the new subject matter in the CIP.

According to yet another embodiment, the system may be configured to ensure that each applicable or all submissions for filing comply with any formalities requirements. For example, the system may ensure that all submitted figures fall within the current guidelines for margins size, line thickness, font size, etc. Such compliance may be determined at any appropriate time, for example, each time a submission is made, whether an initial filing, response to an office action, filing of a continuation, divisional, continuation-in-part of the like.

According to yet another embodiment, the system could generate a clarity score for the patent application. An AI system could be trained to identify patent applications that clearly define an invention vs. applications that do not. End Users and patent examiners could provide a clarity rating for prior art. Based on the ratings assigned, an AI system can analyze newly filed patent applications and assign clarity scores to them.

The system can be built using any suitable architectural method. Examples of suitable architectural methods include, but are not necessarily limited to: 1) a simple, table based method 2) a rules based system or 3) an artificial intelligence (AI) system such as Neural Net, Genetic or Bayesian Algorithm.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components. An exemplary system 100 is shown in FIG. 1 and described below. However, it will be understood that a nearly unlimited number of variations are possible and that such description is intended to provide a non-limiting example of an implementation that could be utilized but should not be used to define the entire scope of the invention.

Accordingly, a system 100 configured to perform the various functions described above may incorporate a number of software modules configured to perform various tasks. Exemplary software modules useful for the presently-described system include:
1. User interface 102—this program allows the end user to interface with system 100.
2. Patent Words and Phrases Dictionary Program 104—this program generates like words and word phrases based on patent application text entered by an end user. These words and phrases may then be stored in a database such as Patent Words and Phrases Database 124, described below.
3. Patent Application Text Enhancement Program 106—this program identifies words and phrases in an end user's patent application and associates these words and phrases with alternative words and phrases from the patent words and phrases dictionary program 104.
4. Web Based Filing Program 108—this program allows patent applications to be created and electronically filed with the patent office.
5. Profile Score Generation Program 110—this program scores the relevance of end users to one another and to patent applications and prior art.

System 100 may further include a number of databases configured to store and associate the various types of data or rules that are used by the system to perform the functions described above. Exemplary databases useful for the presently-described system include:

End User Database 112, which may store and associate data such as:
1. End User ID
2. End User Name
3. End User Address
4. End User Contact Info
5. End User Billing Info
6. Profile Score ID

Patent Application Database 114, which may store and associate data such as:
1. Patent Application ID Number
2. End User ID
3. Patent Application Title
4. Patent Application Abstract
5. Patent Application Description/Specification
6. Patent Application Invention Class and Sub Class
7. Patent Application Inventor Name
8. Patent Application Inventor City
9. Patent Application Inventor State
10. Patent Application Inventor Country
11. Patent Application Attorney or Agent
12. Patent Application PCT Information
13. Patent Application Date of Invention
14. Patent Application Background of the invention
15. Patent Application Invention Figures
16. Patent Application Assignee Name
17. Patent Application Assignee City
18. Patent Application Assignee State
19. Patent Application Assignee Country
20. Patent Application claims
21. Patent Application Search ID
22. Patent Application Researcher
23. Patent Application Filing Date
24. Patent Application Status
25. Profile Score ID
26. Published/Unpublished Flag

Patent Application Status Database 116, which may store and associate data such as:
1. Patent Application Registered
2. Submitted to manual Search
3. Manual Search Received
4. Submitted to Attorney
5. Attorney Review Complete
6. Submitted to Formal Search
7. Formal Search Complete
8. Received Distinguishing Language Over Prior Art
9. Filed
10. Patent Examiner Review
11. Response to Examiner Review
12. Patent Abandoned
13. Final Rejection
14. Patent Issued

Attorney Database 118, which may store and associate data such as:
1. Attorney ID
2. Attorney Name
3. Attorney Address
4. Attorney Billing Info
5. Profile Score ID

Prior Art Database 120, which may store and associate data such as:
1. Prior Art ID
2. Prior Art Title
3. Prior Art Abstract
4. Prior Art Description/Specification
5. Prior Art Invention Class and Sub Class
6. Prior Art Inventor Name
7. Prior Art Inventor City
8. Prior Art Inventor State
9. Prior Art Inventor Country
10. Prior Art Attorney or Agent
11. Prior Art PCT Information
12. Prior Art Date of Invention
13. Prior Art Background of the invention
14. Prior Art Invention Figures
15. Prior Art Assignee Name
16. Prior Art Assignee City
17. Prior Art Assignee State
18. Prior Art Assignee Country
19. Prior Art claims
20. Profile Score ID
21. Related Prior Art Notes IDs 1-N
22. Prior Art Search Score
23. Published/Unpublished Flag

Prior Art Note Database 122, which may store and associate data such as:
1. Note ID
2. End User ID(s)
3. Patent Application ID
4. Prior Art ID(s)
5. Note Title
6. Note Description
7. Note Class
8. Note Subclass
9. Note Keyword(s) 1-N
10. Profile Score ID

Patent Words and Phrases Dictionary Database 124, which may store and associate data such as:
1. Word ID
2. Word
3. Like Words 1-N
4. Common phrases using word or like words 1-N
5. Used in Patents 1-N
6. Profile Score ID

Researcher Database 126, which may store and associate data such as:
1. Researcher ID
2. Researcher Name
3. Researcher Address
4. Researcher Billing Info
5. Profile Score ID

Researcher Queue 128, which may store and associate data such as:
1. Researcher ID
2. Patent Application ID
3. Patent Application Queue Number

Certified Search Database 130, which may store and associate data such as:
1. Search ID
2. Patent Application ID
3. Prior Art ID 1-N
4. Distinguishing Language Over Prior Art 1-N
5. Prior Art Score
6. Novelty Score
7. Usefulness Score
8. Non-obvious Score
9. Search Score
10. Clarity Score

Profile Database 132, which may store and associate data such as:
1. Profile Score ID
2. Profile Type
3. Patent Class 1-N
4. Patent Subclass 1-N

End User Profile 134, which may store and associate data such as:
1. Profile Score ID
2. Patent Application(s) Class 1-N
3. Patent Application(s) Sub Class 1-N
4. Invention Keywords 1-N

Profile Type Database 136, which may store and associate data such as:
1. End User
2. Attorney
3. Researcher
4. Word
5. Patent Application
6. Prior Art

Transaction Database 138, which may store and associate data such as:
1. Transaction ID
2. Transaction Date
3. Transaction Type
4. End User ID (1-N)
5. Researcher ID (1-N)
6. Attorney ID (1-N)
7. Transaction Amount

Transaction Type and Fee Database 140, which may store and associate data such as:
1. Transaction Type
2. Transaction Fee (1-N)
3. Fee Applied to Account Type (1-N)

Accordingly, a system such as that described herein will be configured to perform various functions, such as those described above, by performing various method steps in order to accomplish one or more given tasks. Non-limiting examples of methods that may be performed by a system and the steps that the system may execute in order to perform these methods are described below:

Draft initial patent application:
1. Receive Patent Application Information
2. Receive request for alternate language and missing part suggestions
3. Determine similar patent applications and prior art
4. Determine alternate language and missing portion suggestions based on similar applications
5. Output alternate language and missing portion suggestions
6. Receive patent application modifications based on alternate language and missing portion suggestions

Specify class and subclass:
1. Receive Patent Application Data
2. Determine patent class and subclass based on patent application data
3. Assign class and subclass to patent application based on data received.

Enhance alternate language and missing portion suggestions based on user input
1. Output alternate language and missing portion suggestions based on patent application information
2. Receive relevance score and/or notes on alternate language and missing portion suggestions
3. Store relevance score and/or notes with patent applications and prior art for subsequent use. (Note: the scores can take into account both the prior art and the current invention being submitted, so that the relevance can be determined for later patent applications that are similar to the current application being filed.)

Submit initial application to researcher
1. Receive patent application from end user
2. Receive request to send application to researcher
3. Determine researcher based on patent application, researcher history, and researcher availability
4. Output Researcher Contact Information
5. Receive request to submit application to researcher
6. Submit Application to Researcher
7. Bill end user account a researcher finders fee
8. Bill researcher account a finder's fee
9. Receive a Completed Research Report
10. Submit Report to End User
11. Bill end user account for completed report
12. Remit payment to researcher for completed report.

Rate Researcher based on Research Report Feedback
1. Submit research report to end user
2. Receive feedback for prior art cited in research report
3. Store feedback with prior art cited for subsequent search matches
4. Receive Feedback for Researcher
5. Store feedback with researcher record for subsequent search matches

Submit initial application to attorney for completion
1. Receive patent application from end user
2. Receive request to send application to attorney
3. Determine attorney based on patent application, attorney history, and attorney availability
4. Output Attorney Contact Information
5. Receive request to submit application to attorney
6. Submit Application to Attorney
7. Bill attorney account a finder's fee
8. Bill end user account an attorney finder's fee
9. Receive Completed Application
10. Notify end user application has been received

Submit application to patent office
1. Receive Patent Application
2. Determine if there are missing parts
3. Output List of Missing Parts
4. If there are no missing parts, generate appropriate filing forms
5. Submit Application to Patent Office
6. Bill end user account a filing fee
7. Remit filing fee to patent office
8. Receive notice from patent office that application was received
9. Store notice and output notice to end user.

Submit application to central system for time and date stamp
1. Receive Patent Application Data
2. Receive indication that patent application should be submitted for a disclosure date
3. Time and Date stamp patent application data
4. Receive request to make patent application data public or private
5. Store patent application data with time stamp and public or private flag.

Find like inventors
1. Receive Patent Application Data
2. Search Patent Application Data against End User Profiles
3. Determine Relevant End User Profiles
4. Score Relevant End User Profiles
5. Output end user profiles in order of their scores

According to yet another embodiment, the present disclosure provides a system and method for providing certified third party searches. According to one aspect of this embodiment, an end user may create a patent application. Either the system or an end user determines a class and subclass for the patent application. Based on the patent class and subclass, a list of potential researchers is generated. The system selects a researcher from the list based on any number of factors, including, for example, the queue of patent applications each researcher has, the class and sub class of the patent being filed, and the class and subclasses for which the researcher is considered an expert. According to one aspect, a researcher can be selected based on keywords in the patent application.

According to one embodiment, the invention is submitted to the researcher to be researched. In certain embodiments, the system does not disclose the end user or assignee to the researcher. The researcher conducts a prior art search and attaches relevant digital prior art to the patent application record. The researcher can highlight sections of the prior art and site the specific sections of the prior art as relevant to specific sections of the patent application. Alternatively, a researcher can embed specific section of prior art as notes into a patent application.

The researcher may submit the patent application with added prior art data to the system and the system may certify the search.

According to an embodiment, an end user may receive a notice indicating that the researcher has completed a certified search for the submitted patent application. The end user can log in to the system and retrieve the patent application along with the certified search data. The end user can then provide distinguishing language over the prior art and submit the patent application, the certified search, and the distinguishing language to the central system to be filed and reviewed.

According to another embodiment, while the end user is entering the patent application data into the system, the system can determine an appropriate researcher and offer the opportunity to provide the end user with real time chat with a researcher. If the end user accepts, a chat window, or equivalent communication method/portal may be opened between the end user and researcher via the central system. The end user can provide patent application data and the researcher can provide relevant prior art. When the session is complete, the system can charge a fee to the end user and submit a portion of that fee to the researcher. The recorded chat session may be attached to the patent application file.

Accordingly, a system such as that described herein will be configured to perform various functions, such as those described above, by performing various method steps in order to accomplish one or more given tasks. Non-limiting examples of programs or modules that may be employed by a system according to the present disclosure include the following programs which may have the following architectures and/or capabilities:

Central Server
1. Researcher Selection Program
2. Certified Search Program
3. Billing Program

System 10 may further include a number of databases configured to store and associate the various types of data that are used by the system to perform the functions described above. Exemplary database architectures useful for the presently-described system include:
1. Researcher Database
   a. Researcher ID
   b. Researcher Profile
   c. Researcher Billing and Account Information
   d. Researcher Search Score
2. End User Database
   a. End User ID
   b. End User Profile
   c. End User Billing Info
   d. End User Score
3. Patent Application Database
   a. Creation Date
   b. Patent Application ID
   c. Patent Application Status
   d. End User ID
   e. Researcher ID
   f. Patent Application Data
   g. Research Report ID
4. Prior Art Database
   a. Prior Art ID
b. Prior Art Content
   c. Prior Art Date
5. Researcher Schedule Database
   a. Researcher ID
   b. Patent Application ID 1-N
   c. Patent Application Research Target Date 1-N
6. Research Report Database
   a. Research Report ID
   b. Patent Application ID
   c. Prior Art ID 1-N

Accordingly, a system such as that described herein will be configured to perform various functions, such as those described above, by performing various method steps in order to accomplish one or more given tasks. Non-limiting examples of methods that may be performed by a system according to the present disclosure include the following:

Select Researcher
1. Receive Patent Application Data
2. Determine Appropriate Researcher based on Patent Application Data
3. Submit Patent Application to Researcher

Real Time Chat with Researcher
1. Receive Patent Application Data
2. Determine Appropriate Researcher based on Patent Application Data
3. Determine if Researcher is available for Real Time Chat
4. If Researcher is available for real time chat, output offer for real time chat to end user
5. Receive acceptance of offer from end user
6. Initiate Chat session
7. Receive indication that chat session is complete
8. Store chat session with patent application data
9. Determine Fee for Chat Session
10. Charge End User Account Fee
11. Remit a portion of the fee to the Researcher

Create Certified Search
1. Output Patent Application
2. Receive Research Results
3. Store Results with Patent Application Data
4. Output notice to end user that certified search is complete
5. Determine Fee for Certified Search
6. Apply fee to end user account
7. Remit a portion of fee to researcher account

File Patent Application
1. Output Patent Application Data with Certified Search
2. Receive Distinguishing Language
3. Store Distinguishing Language with Patent Application Data
4. File Patent Application Data, Certified Search, and Distinguishing Language with Patent Office
5. Determine Fee
6. Apply fee to end user account

According to one further embodiment, a system is provided wherein prior art searches for patent-related document are automatically generated. An end user can submit a patent application to a central system, for example via the web-based form described in U.S. patent application Ser. Nos. 11/668,596, 11/668,586, 11/611,024, 11/462,621 and 60/727,191 each of which is hereby incorporated by reference in its entirety, and as described in greater detail below. Of course it will be appreciated that this system could be implemented using any standard mechanism for submitting a patent application and that known methods, such as scanning and OCR, can be used to turn applications submitted in paper form into electronic applications which can then be entered into the presently described system.

Once the patent application is submitted, the system uses a genetic algorithm or other similar mechanism to automatically identify relevant prior art. The system may output the prior art in order of its relevancy. Relative relevancy may be determined based on a score generated by the system. The end user may also be able to review the identified prior art and rate its relevance to the patent application submitted.

The end user can also submit notes about or related to the identified prior art. The submitted notes and relevance ratings are stored with the prior art and may be used as criteria on subsequent patent application searches. Over time prior art is given a stand-alone relevance score and a relevance score for each patent application in which it was cited. Relevance may be based on any number of suitable factors which may be determined solely by the system and/or may be determined by the end-user's and/or other reviewer's actions. For example, if the end-user ultimately includes a prior art reference found and presented by the system, that particular piece of prior art may be assumed to have been relevant. If the end-user decides not to include a particular prior art reference that has been found by the system, that piece of prior art may or may not be considered to be relevant.

The end user can elect to save some or all of the search results with the patent application. The end user can also write language to distinguish the patent application over the prior art search results and/or amend the claims of the patent application to distinguish over the prior art cited. Any language in the patent application that is added, altered, or deleted by the end user in response to the automated search results may be identified by the system as an “amendment” to the application. Such amendment may be stored with a time and date stamp. The central system can certify the search results as being unaltered by the end user, and the patent application and any “amendments” can be submitted along with the certified search results to the patent office for filing.

As a further embodiment, the system can be used to generate the first office action for a patent application. The automated search results are treated as the first office action. The “amendments” submitted by the end user in response to the automated prior art search can be treated as a response to the first office action. The automated search results along with the end user's “amendments,” notes, and comments can then be submitted to an examiner, who can then develop a second office action. The system could therefore be used to automate an entire step of the patent filing and issuance process.

When the application is published and/or issued, the system could then display the patent application, prior art or search results, and/or end user's notes to future applicants, whose applications include the same or similar prior art, i.e., to assist them in distinguishing their invention over the same or similar prior art. For example, an end user's notes may identify that a particular invention is not or only partially enabled or a particular combination is or is not obvious. These types of comments could then prove useful to other practitioners, particularly if a given argument was found to be persuasive by an examiner.

In another embodiment, the automated search tool described herein can also be used to find prior art on issued patents. The end user submits the issued patent title or number to the system and the system finds the most relevant prior art with a date prior to the filing date of the submitted issued patent. The system can assemble the prior art on each issued patent in real time, i.e. when the prior art request is submitted. Alternatively, the system can classify issued patents with prior art all the time, i.e. on an on-going basis, and have pre-assembled search results and/or reports available on demand or request for issued patents. The central system can certify the search results so that they can be used by multiple parties who can use them as the basis for invalidating a patent, one or more of its claims, or determining the novelty of an issued patent and/or one or more of its claims. The system maintains a database of all searches, notes and search results for any issued patents, and for any new searches for the pending application. This information helps the system to determine a relevancy score, i.e., if another applicant uses the same or similar search, the results, prior art, notes, etc., from the first application could be available to any subsequent application(s).

Regardless of whether the system is used to search a patent application or an issued patent, the system can generate a novelty score of the document over the prior art it cites and/or that the system determines as relevant. The novelty score can be generated by the system based on how close the prior art cited comes to disclosing the invention disclosed in the document submitted by the end user.

Researchers can use manual searching or automated search engines to complete any search, this may be especially useful when the system is new and just beginning to build a prior art database. Researchers can then enter or list any relevant prior art and, optionally, assign their own relevancy scores and/or attach one or more notes. These data would be used to train the system to conduct and enhance its own searches. Additionally the system could request and optionally pay attorneys and researchers to provide this feedback. The feedback could be ranked by comparing it to the feedback from other end users. Researchers and Attorneys who provided the most accessed, cited or relevant feedback could be paid the greatest fees or greatest share of fees.

According to yet another embodiment, end users can submit prior art and/or hyperlinks to prior art to a confidential database where it can be stored, certified or otherwise used as prior art for submitted, yet unpublished, patent applications. Patent examiners or any other authorized end users can access such prior art and use it to distinguish over submitted patent applications. The search system can use the unpublished or other prior art and cite is as references to newly submitted patent applications. The search system can additionally generate novelty scores for the newly submitted patent applications based on the unpublished prior art and/or end user submitted novelty scores. Should an examiner cite unpublished prior art as a reason for not issuing a patent or one or more of its claims, the end user can request at least one second opinion from another examiner.

End users can also submit unpublished prior art as prior art for an issued patent. The system can use the unpublished prior art to generate a novelty score for the issued patent. Patent examiners can review the issued patent in light of the unpublished prior art and determine if the patent and/or one or more of its claims should be invalidated. In this manner, file wrappers for issued patents can continue to expand after a patent has issued. The ever-expanding file wrapper can be used, in whole or in part, to determine the value of a patent for licensing purposes. An issued patent with a low novelty score can have a generally lower or different licensing value then an issued patent with a generally higher novelty score.

The system can search both public and unpublished prior art. In the case of public prior art, the system can cite references and output them to the end user. (And can, optionally, insert references and/or hyperlinks in the end user's application). In the case of unpublished prior art, the system can generate a novelty score and certify the search results. The end user can elect to continue filing or prosecuting the patent based on the novelty score. The unpublished, certified results can be reviewed by a patent examiner in determining whether or not to issue a patent on the claimed invention.

As a non-limiting example, a piece of prior art may be determined to be relevant based on:
1. The number, order and/or use of similar phrases, or words or synonyms in the patent application and the prior art
2. The relevance score that prior art has been given to patent applications similar to the current application.
3. The number of times a piece of prior art has been cited in patent applications in the same field, class, and subclass of the patent application.
4. The relevance of the prior art to other patent applications previously filed by the end user in the class and sub class of the patent application
5. Common attorney or agent between the patent application and the prior art.
6. The relationship of the end user of the patent application to the end users that are inventors, attorneys, or assignees of the prior art.

Information found in one or more invention fields may be considered during the automated prior art search. Non-limiting examples of invention fields that may be considered suitable for review during the invention search include:
1. Title
2. Abstract
3. Issue Date
4. Patent Number
5. Application Date
6. Application Serial Number
7. Application Type
8. Assignee Name
9. Assignee City
10. Assignee State
11. Assignee Country
12. International Classification
13. Current US Classification
14. Primary Examiner
15. Assistant Examiner
16. Inventor Name
17. Inventor City
18. Inventor State
19. Inventor Country
20. Government Interest
21. Attorney or Agent
22. PCT Information
23. Foreign Priority
24. Reissue Data
25. Related US App Data
26. Referenced By
27. Foreign References
28. Other References
29. Claims
30. Description/Specification
31. Notes

As a further embodiment, as patent application data is entered, the system could determine relevant prior art and output results in real time via the web-based application. Prior art or hyperlinks to the prior art could be incorporated into or otherwise associated with the patent application as the application is being drafted or when filed, examined or prosecuted. (Output formats could be a simple listing, sorted or unsorted in order of relevancy, tree structure, showing links, or a “web” mapping, showing links among all patents and other prior art, published or otherwise).

If an end user indicates that a particular prior art reference cited is particularly relevant to the patent application, the system can retrieve prior art that is relevant to the prior art reference in real time and display it to the end user either automatically or by request. As end-users indicate manual relevancy scores, the system could weight that information based upon the end-user's role (applicant, researcher, and attorney) and/or based upon their proven ability to effectively score in the past. All end-users can score each other's performance, which may also affect the system's weighting of such scores (individually and collectively).

As the end-user is typing in a search term or phrase, the system could simultaneously: a) retrieve the relevant prior art, continuously updating the list as the search term or phrase is changed or completed and b) offer up completed terms or phrases that are similar (i.e., past searches) or relevant to the current search. In other words, multiple search windows could open up on the end user desktop showing completed search phrases that might be of interest to the current searcher. These searches could also be displayed based upon relevancy and/or how recent the search was submitted and/or popularity, i.e., how often it has been used.

The system could assemble and store a profile for each user that contributes to, or otherwise helps the system better understand the type of patent applications that a given user files, searches on, etc. So that the system could determine that, for example, an end user generally files more process patents, e.g., software related as opposed to generally fewer device patents. This information could aid any of the online tools and search engines to place a higher priority on the generally more applicable prior art, suggestions, etc.

The system could highlight the more relevant sections of prior art with different colors or other font styles or attributes or other indicators to reflect the degree of potential infringement. The end user and patent examiner can add feedback to the cited prior art reference to indicate whether the reference was flagged with the appropriate color or other attributes. This feedback could be used by an artificial intelligence algorithm to improve the generation of relevant prior art for subsequent searches.

End users and patent examiners can add notes to a patent application or prior art reference. Such notes could be presented in any suitable form including, for example, in the form of a rollover pop up window.

Keyword analysis can determine the common use of rare vs. common words in two or more documents. For purposes of document comparisons, common words can then be discarded. The matching of rare words between documents could affect the relevancy score between the documents.

In another embodiment, the results of a search may be based both on the invention being submitted and previous inventions submitted by the end user.

The system can be built using any suitable architectural method. Examples of suitable architectural methods include, but are not necessarily limited to: 1) a simple, table based method 2) a rules based system or 3) an artificial intelligence (AI) system such as Neural Net, or Bayesian Algorithm.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components. A suitable exemplary system 200 is shown in FIG. 2. However, it will be understood that a nearly unlimited number of variations are possible and that such description is intended to provide a non-limiting example of an implementation that could be utilized but should not be used to define the entire scope of the invention.

Accordingly, a system 200 configured to perform the various functions described above may incorporate a number of software modules configured to perform various tasks. Exemplary software modules useful for the presently-described system include:
1. Certified Search Program 212—This program conducts an AI prior art search for a submitted patent application and links the search results to a patent application
2. Novelty Score Program 214—This program generates a novelty score of a patent application as they relate to the certified search results.
3. Generate End User Profile Program 216—this program generates an end user profile based on patent applications submitted by an end user.

System 200 may further include a number of databases configured to store and associate the various types of data that are used by the system to perform the functions described above. Exemplary databases useful for the presently-described system include:
End User Database 218
1. End User ID
2. End User Name
3. End User Address
4. End User Contact Info
5. End User Billing Info
6. Profile Score ID

Patent Application Database 220
1. Patent Application ID Number
2. End User ID
3. Patent Application Title
4. Patent Application Abstract
5. Patent Application Description/Specification
6. Patent Application Invention Class and Sub Class
7. Patent Application Inventor Name
8. Patent Application Inventor City
9. Patent Application Inventor State
10. Patent Application Inventor Country
11. Patent Application Attorney or Agent
12. Patent Application PCT Information
13. Patent Application Date of Invention
14. Patent Application Background of the invention
15. Patent Application Invention Figures
16. Patent Application Assignee Name
17. Patent Application Assignee City
18. Patent Application Assignee State
19. Patent Application Assignee Country
20. Patent Application claims
21. Patent Application Search ID
22. Patent Application Researcher
23. Patent Application Filing Date
24. Patent Application Status
25. Profile Score ID
26. Published/Unpublished Flag

Patent Application Status Database 222
1. Patent Application Registered
2. Submitted to Formal Search
3. Formal Search Complete
4. Received Distinguishing Language Over Prior Art
5. Patent Application Filed
6. Patent Examiner Review
7. Response to Examiner Review
8. Patent Abandoned
9. Final Rejection
10. Patent Issued

Attorney Database 224
1. Attorney ID
2. Attorney Name
3. Attorney Address
4. Attorney Billing Info
5. Profile Score ID
6. Qualifications 1-N

Prior Art Database 226
1. Prior Art ID
2. Prior Art Title
3. Prior Art Abstract
4. Prior Art Description/Specification
5. Prior Art Invention Class and Sub Class
6. Prior Art Inventor Name
7. Prior Art Inventor City
8. Prior Art Inventor State
9. Prior Art Inventor Country
10. Prior Art Attorney or Agent
11. Prior Art PCT Information
12. Prior Art Date of Invention
13. Prior Art Background of the invention
14. Prior Art Invention Figures
15. Prior Art Assignee Name
16. Prior Art Assignee City
17. Prior Art Assignee State
18. Prior Art Assignee Country
19. Prior Art claims
20. Profile Score ID
21. Related Prior Art Notes IDs 1-N
22. Prior Art Search Score
23. Published/Unpublished Flag

Prior Art Note Database 228
1. Note ID
2. End User ID(s)
3. Patent Application ID
4. Prior Art ID(s)
5. Note Title
6. Note Description
7. Note Class
8. Note Subclass
9. Note Keyword(s) 1-N
10. Profile Score ID

Virtual Dictionary Database 230
1. Word ID
2. Word
3. Like Words 1-N
4. Common phrases using word or like words 1-N
5. Used in Patents 1-N
6. Profile Score ID

Certified Search Database 232
1. Search ID
2. Patent Application ID
3. Prior Art ID
4. Novelty Score
5. Usefulness Score
6. Non-obvious Score
7. Search Score

Distinguishing Language Database 234
1. Patent Application ID
2. Prior Art ID
3. Referenced Section of Prior Art ID
4. Distinguishing Language over Referenced Section of Prior Art ID

Profile Database 236
1. Profile Score ID
2. Profile Type
3. Patent Class 1-N
4. Patent Subclass 1-N

End User Profile 238
1. Profile Score ID
2. Patent Application(s) Class 1-N
3. Patent Application(s) Sub Class 1-N
4. Invention Keywords 1-N

Profile Type Database 240
1. End User
2. Attorney
3. Word
4. Patent Application
5. Prior Art

Transaction Database (for search, novelty score, and filing fees) 242
1. Transaction ID
2. Transaction Date
3. Transaction Type
4. End User ID (1-N)
5. Transaction Amount

Transaction Type and Fee Database 244
1. Transaction Type
2. Transaction Fee (1-N)
3. Fee Applied to Account Type (1-N)

Accordingly, a system such as that described herein will be configured to perform various functions, such as those described above, by performing various method steps in order to accomplish one or more given tasks. Non-limiting examples of methods that may be performed by a system and the steps that the system may execute in order to perform these methods are described below:

Submit patent application and receive relevant search results
1. Receive Patent Application
2. Determine relevant prior art for patent application
3. Generate relevance score for each piece of relevant prior art
4. Sort relevant prior art in order of relevance score
5. Output Sorted Relevant Prior Art
6. Receive feedback on relevant prior art
7. Store feedback on relevant prior art with prior art record.

Receive distinguishing language of relevant prior art and submit patent application, relevant prior art, and distinguishing language to patent office
1. Receive Patent Application
2. Generate and Output relevant prior art
3. Receive distinguishing language of relevant prior art
4. Submit patent application, relevant prior art, and distinguishing language to patent office

Generate novelty score of patent application based on relevant prior art
1. Receive Patent Application
2. Determine relevant prior art for patent application
3. Generate novelty score for patent application based on relevant prior art
4. Output novelty score based on prior art

Generate end user profile
1. Receive Patent Application
2. Determine Relevant Prior Art
3. Store relevant prior art with End User Profile

Determine relevant prior art based on end user profile and patent application data
1. Receive End User Log in
2. Retrieve End User Profile
3. Receive Patent Application
4. Determine relevant prior art for patent application based on patent application data and end user profile
5. Generate relevance score for each piece of relevant prior art based on patent application data and end user profile
6. Sort relevant prior art in order of relevance score
7. Output Sorted Relevant Prior Art

End User Rates Relevance of Prior Art Cited
1. Receive Patent Application Data
2. Generate prior art based on application data
3. Output prior art based on application data
4. Receive relevance rating of prior art from end user
5. Store relevance rating of prior art with prior art for subsequent scoring

Certified Search of Issued Patent
1. Retrieve Issued Patent Record
2. Generate prior art based on Issued Patent Data
3. Apply relevancy score to prior art
4. Store prior art and score with Issued Patent record.

Real Time Output of Prior Art as Patent is Drafted
1. Receive Patent Application Data
2. Determine prior art based on patent application data
3. Output prior art based on patent application data
4. Receive request to incorporate prior art into patent application data
5. Incorporate prior art into patent application data

Retrieve more prior art relevant to cited prior art
1. Receive Patent Application Data
2. Determine prior art based on patent application data
3. Output prior art based on patent application data
4. Receive request for additional prior art relevant to output prior art
5. Determine additional prior art relevant to output prior art
6. Output Additional Prior Art

Submit patent application for time stamp
1. Receive Patent Application Data
2. Receive Request for Time Stamp
3. Receive Unpublished or Published Preference
4. Time Stamp Patent Application Data
5. Store patent application data with time stamp and unpublished or published preference
6. Publish patent application data if published preference is received

According to another embodiment, the present disclosure provides a patent examination system utilizing enhanced search techniques and end user feedback on prior art data. According to one aspect of this embodiment, a patent application is submitted for filing with the patent office via a web-based central system. Prior to its submission, or immediately thereafter, the system performs a prior art search against its prior art database. Prior Art is scored as to its relevancy to the patent application and ranked in order of its relevance. The most relevant or all results are certified and stored with the patent application and the certified search results can be used by patent examiners to perform office actions or to conduct further review.

If the search was performed prior to the patent application being submitted for filing, the end user filing the application could also have provided notes to distinguish the invention over the prior art cited. These notes are associated with and/or stored with the patent application and certified search results and can be considered or used as the first office action of the invention.

According to one embodiment, prior art is scored as relevant by a statistical, rules-based or artificial intelligence system based on any one or several criteria including:
1. Common words and phrases in the patent application and the prior art
2. The class and sub class of the patent application and the prior art
3. The amount of time the prior art was considered by the end user, search professional, patent attorney and/or examiner on the same or similar patent applications
4. The notes an end user or patent examiner has attached to the prior art
5. The office actions performed by the system or patent examiners utilizing the same prior art on similar patent applications (and their rejection rates)
6. The patent application data of the patent application and the data of the prior art
7. The number of examiners and or end users who have reviewed or cited the prior art for similar patent applications in the past
8. The seniority or ranking of patent examiners who have cited the prior art for the similar patent applications in the past
9. The number of times the prior art data is cited in similar patent applications
10. The number of times the prior art data is accessed or the duration of such access by one or more end users and patent examiners to conduct searches on similar patent applications
11. The existence of any published or unpublished applications pending or previously reviews and/or rejected.

According to an embodiment, a patent examiner can review the submitted patent application, the certified prior art search, any notes and the distinguishing language provided by the end user and draft an office action using the three files. The office action may contain notes about the prior art, the patent application, and the distinguishing data that will be stored with both the patent application and the prior art to be used to score them against new patent applications later.

According to another embodiment, as patent applications are filed, they become prior art for subsequent patent applications. For example, based on the end user preference, the patent application can be published or unpublished prior art. If it is unpublished prior art, it can only be reviewed by patent examiners, who can use it as prior art on subsequent patent applications. The central system can also conduct certified searches using published and/or unpublished prior art acquired in this manner. When such a prior art document is cited as a reference, the end user is optionally made aware that there may be prior art that could invalidate his patent application, but he must rely on the patent examiner to examine the application and the unpublished prior art and notify him as to whether the unpublished prior art could or does invalidate his patent. If an end user is notified by a patent examiner that unpublished prior art invalidates his patent, he can request a reexamination of the patent by another examiner or submit the matter to a review process established for such purposes.

Alternatively or additionally, the end user may be able to request that the unpublished prior art be published.

According to another embodiment, if the patent applications are published, they can be viewed by the end users and patent examiners of subsequent patent applications alike.

According to some embodiments, notes attached to prior art can also be published or unpublished by the central system. Unpublished notes would be available to patent examiners, their peers, and the central system and/or any other authorized end users for review of subsequent patent applications. Published notes can be reviewed by patent examiners and end users alike and can be used by both parties and the AI search system to consider the validity of subsequent patent application claims.

As with patent applications, published notes may be reviewed by other inventors, researchers, attorneys, etc., any of whom may challenge the application or notes by submitting their notes or opinions to the system. They may also assign a weighting factor to their commentary (from low to high). These rankings can be tracked and measured to determine the relative value and weight each contributor should receive regarding any such existing and/or future commentaries. In this way the system, either statistically based, manually based, rules based or AI based, can establish a track record for each critic, which can then be used to weight any future submissions. In this way, a comment from critic that regularly contributes commentary and is insightful or “right” most of the time will carry more weight than critics that prove “wrong” more often. This would push comments to the top of the list that the examiner might review.

Alternatively or additionally, when a critic submits commentary, the system could search its own database or other databases, e.g., via the Internet to determine the credentials of the critic. Submissions from unknown persons might carry less weight, whereas submissions from people having a known reputation, such as the Chief Justice of the Supreme Court of the United States, could carry greater weight. This would provide a means to weight comments, especially early in the systems' life cycle, when there is no track record.

Furthermore, in addition to or instead of a system ranking, the examiners could provide the system with feedback on the relative usefulness of any given critics' commentary. The database should track human and machine derived rankings on any commentary for every critic. These then can be used after the examination to determine which sources are best able to provide meaningful input as it relates to the actual/final outcome of each application.

According to another embodiment, the system could automatically require the examination of a patent application by two or more examiners if the prior art cited that invalidates the patent claims is unpublished. In this manner, two (or more) examiners will have reviewed the unpublished prior art data before an office action is submitted to the central system for distribution back to the end user.

Any such peer review might be either public or anonymous, i.e., the primary examiner may or may not be informed as to who the second (or additional) examiner is/are. Using this method the system could randomly assign internal reviews, and/or the system could learn which peer to use for each type of application, using similar or dissimilar relevancy and efficiency scores. If the review is anonymous, the examiner could request a conference with the examiner so as to ask questions face-to-face. If the anonymous reviewer refuses, the system could, instead, arrange a time for an anonymous instant message session so that each person could “discuss” the reviewer's point of view. Alternatively, the peer reviewer might only agree to an anonymous dialog via messages (via e-mail but using an anonymous temporary alias account that is forwarded and managed between the parties).

According to another embodiment, the certified search submitted with the patent application can be periodically refreshed by the search system to insure that newly acquired prior art with early filing dates is included in the certified search query and subsequent scored results.

According to another embodiment, if new prior art is found that may also have a high relevance score to a patent application and the patent application has not yet been reviewed by the patent examiner, the end user can be notified, for example, via an alert, that new prior art has been found and included as part of the certified search. Suitable alerts are described, for example, in U.S. patent application Ser. No. 11/676,848, which is incorporated by reference. The end user can then be given the opportunity to distinguish over the new prior art and his distinguishing language can be included as part of the first office action notes he submits to the patent office for review. In this manner, the central system can conduct a more thorough, ongoing search of prior art for a filed patent application thereby improving the quality of the patent applications and office actions. Any third parties that may have submitted notes/commentary/argument may also be notified of any such “new prior art” to be given the same opportunity to review such additional prior art and/or to submit additional notes.

The end user, a researcher, or the patent examiner, can also conduct a manual search, i.e. one performed without using the artificial intelligence or other search program(s) of the central system. Should the examiner find relevant prior art in a manual search that was not included in the certified search, that prior art can be added to the certified search, along with notes. Such addition of prior art may be accomplished via any applicable means, including, copying or referencing the prior art using a hyperlink into the prior art database, or by listing such prior art's title, application or other identification number or means The artificial intelligence program can use the prior art that is manually submitted in this manner to improve its own database of information, and/or improve its search or other rules, methods or algorithms so that later certified searches that it performs are generally more accurate. In this manner, end users and patent examiners teach the artificial intelligence program or other determination methods how to do a better job of certified searching.

In order to acquire its first learning, the artificial intelligence system can revisit the steps taken by patent examiners on previously examined patent applications. File wrappers of previous patent applications can be analyzed by the artificial intelligence and used as a first criteria to develop or preload an initial set of rules to conduct certified searches on subsequent patent applications that are submitted to the patent office via the central web-based system.

Alternatively, existing search engine algorithms may serve as the Genetic Programming system as its base programs. These then can be subjected to normal GP techniques such as cross mutation, etc., to create a self-improving network (search tool).

The system can be built utilizing three different architectural methods: 1) a simple, table based method 2) a rules based system or 3) an artificial intelligence (A) system such as Neural Net, or Bayesian or other Genetic Algorithms.

According to another embodiment, examiners could submit questions or requests to existing patent holders (prior art to the pending application) or others with similar patents, or researchers or attorneys, to get their input about the pending patent application. Since the application is already filed, those queried could not claim authorship, but would/may have a vested interest in the application and may have opinion as to the validity of the pending application. Such feedback could become part of the application notes. In some embodiments, end users that provide such opinions may be paid a fee for such opinions. Such fees may be determined via any applicable means, including based upon any available factors, for example, such end users qualifications and/or rankings and/or based upon the frequency or extent such opinions are used or otherwise relied upon by any person, e.g., patent examiner, etc.

If availability of the applicant and the examiner do not coincide, an off-line communications may be established using e-mail or recorded voice or text messages or a combination of these, for example, an email message may include a title and an attachment of a voice message.

Accordingly, a system according to the present disclosure may be configured to perform the various functions described above and may incorporate one or more servers capable of running any number and/or combination of software modules configured to perform various tasks. Exemplary combinations of servers and software modules useful for the presently-described system include:

Central Server
1. Certified Search Program
2. Examination Program
3. Reexamination Program
4. Notes Program
5. Alerts Program

A system according to the present disclosure may further include a number of databases configured to store and associate the various types of data that are used by the system to perform the functions described above. Exemplary database architectures useful for the presently-described system include:

End User Database
1. End User ID
2. End User Profile
3. End User Billing Info
4. End User Score
5. End User Historical Information
6. Qualifications 1-N

Patent Examiner Database
1. Examiner ID
2. Examiner Profile
3. Examiner Word Load
4. Examiner Score
5. Cases Pending/Prosecuted 1-N
6. Qualifications

Patent Application Database
1. Application ID
2. End User ID
3. Examiner ID
4. Application Data
5. Application Status
6. Certified Search ID
7. Application Filing Date
8. Distinguishing Language Data
9. Response to Distinguishing Language Data
10. Additional Relevant Prior Art Data
11. Response to Additional Prior Art Data
12. Notes 1-N

Certified Search Database
1. Search ID
2. Researcher ID
3. Prior Art Reference 1-N

Prior Art Database
1. Prior Art ID
2. Prior Art Type
3. Prior Art Date
4. Prior Art Content
5. Prior Art Notes 1-N
6. Note Taker ID 1-N
7. Prior Art Note Dates 1-N

Accordingly, a system such as that described herein will be configured to perform various functions, such as those described above, by performing various method steps in order to accomplish one or more given tasks. Non-limiting examples of methods that may be performed by a system according to the present disclosure include the following:

Conduct Certified Prior Art Search and First Office Action
1. Receive Patent Application Data
2. Retrieve Prior Art
3. Compare Patent Application Data to Prior Art
4. Identify Relevant Prior Art Documents
5. Store Relevant Prior Art Documents with Patent Application and Time Stamp
6. Notify End Users

Receive Response to First Office Action
1. Output Patent Application Data with Relevant Prior Art Documents
2. Receive Distinguishing Language over Prior Art
3. Store Distinguishing Language with Patent Application Data and Time Stamp
4. Receive Request to File Patent Application Data
5. Create Patent Application ID Number
6. Determine Patent Application Class and Subclass
7. Determine Fee for Patent Application Filing
8. Apply fee to End User Account

Create Second Office Action
1. Receive Request to Examine Patent Application
2. Output Patent Application, Relevant Prior Art, and Distinguishing Language
3. Receive Response to Distinguishing Language
4. Receive Additional Relevant Prior Art
5. Receive Comments on Additional Prior Art
6. Store Response to Distinguishing Language, Additional Relevant Prior Art and Comments on Additional Prior Art with Patent Application and Time Stamp

Receive Response to Second Office Action
1. Receive request to review Response to First Office Action
2. Output Patent Application, Response to Distinguishing Language, Additional Relevant Prior Art, and Comments on Additional Prior Art
3. Receive Additional Distinguishing Language
4. Store Patent Application with Additional Distinguishing Language and Time Stamp
5. Determine Fee for Office Action
6. Apply Fee to End User Account

Receive Reexamination Request if Prior Art Cited in Second Office Action Was Unpublished
1. Receive request to review Response to First Office Action
2. Output Patent Application, Response to Distinguishing Language, Additional Relevant Prior Art, and Comments on Additional Prior Art
3. Receive Request for Reexamination if Additional Prior Art Cited was Unpublished.

Automatic Second Opinion if prior art is unpublished
1. Receive Request to Examine Patent Application
2. Output Patent Application, Relevant Prior Art, and Distinguishing Language
3. Receive Response to Distinguishing Language
4. Receive Additional Relevant Prior Art
5. Receive Comments on Additional Prior Art
6. Store Response to Distinguishing Language, Additional Relevant Prior Art and Comments on Additional Prior Art with Patent Application and Time Stamp
7. If Additional Prior Art Cited was unpublished, determine a Second Examiner and Place Patent Application in Second Examiner Queue
8. Output notification to End User that Patent Application is Receiving Second Examination because Additional Prior Art cited by first examiner was unpublished.

Automated Refresh of Search Results
1. Retrieve Patent Application Data and Certified Search
2. Compare Patent Application Data to Prior Art Data
3. Generate list of Relevant Prior Art
4. Compare list to Certified Search
5. If list has additional prior art references, store references with Patent Application Data
6. Output notice to end user that patent application has received additional prior art references.

Redo First Office Action if New Prior Art is found
1. Receive request to review additional prior art
2. Output Patent Application Data and Additional Prior Art
3. Receive Additional Distinguishing Language over Additional Prior Art
4. Store Additional Distinguishing Language with Patent Application and Time Stamp
5. Determine Fee for filing Additional Distinguishing Language
6. Apply Fee to End User Account.

Improve Artificial Intelligence Search Results Based on Manual Prior Art
1. Output Patent Application Data and Certified Search
2. Receive Additional Prior Art References
3. Use Additional Prior Art References to Enhance Genetic Algorithm that created Certified Search.

Additions to Certified Search Results
1. Output Patent Application Data and Certified Search
2. Receive Additional Prior Art References
3. Store Additional Prior Art References as Part of Certified Search and Time Stamp

Use File Wrapper Data to Train Artificial Intelligence Program
1. Receive File Wrapper Data
2. Use File Wrapper Data To Train Genetic Algorithm to Conduct Certified Searches

According to yet another embodiment, the present disclosure provides an electronic patent file wrapper system and method for managing electronic correspondence for a patent application. According to one aspect of this embodiment, an end user creates a patent application by entering patent application data into a web-based system. The date that the patent application was received is time stamped and stored with the file. A fee is generated for submitting the application and the end user account is charged the fee. The system generates a notice that a fee has been charged and transmits the notice to the end user.

Upon receipt of payment, or an equivalent promise to pay, by the applicant, the system can determine relevant researchers to conduct prior art research on the patent application and outputs an offer to the end user to transmit the patent application to the researcher. Alternatively, the applicant can conduct and submit their own research and/or engage their own firm. The date that the request for research was received is time stamped and stored with the file. If the end user accepts the offer, the patent application is stored and a notice is sent to the researcher that a patent application needs to be researched.

When the researcher has completed his research of the patent application, the prior art files can be added to a search folder linked to the patent application file along with any notes or commentary provided by the researcher. The date that search folder was completed and received and/or updated is time stamped and stored with the file. When the researcher completes the prior art file folder and submits it to the central system via a web based form or other submission tool, the end user may be notified that the prior art search is complete.

According to a further embodiment, a fee is generated for researching the application and, for example, the end user account is charged the fee, and the researcher account is credited a portion of the fee. The system generates a notice that a fee has been charged and transmits the notice to the end user. The system generates a notice that a credit has been applied, and transmits the notice to the researcher.

According to another embodiment, the end user or other authorized end users can log in to the system to review the prior art file. The end user can also retrieve the patent application and add more data to or change it. Whenever the patent application file is accessed and or amended, a time stamp is recorded along with the end user's id and the amendment and stored with the patent application file. Amendments may be recorded as “change tracking” or stored as a new file.

According to an embodiment, the system determines relevant attorneys to complete and enhance the patent application data and outputs an offer to the end user to transmit the patent application to the attorney. If the end user and/or attorney accepts the offer, the patent application is stored and a notice is sent to the attorney that a patent application needs to be researched. The date that the request for an attorney was received may be time stamped and stored with the file, along with the attorney's identifier code.

According to an embodiment, when the attorney has completed and or enhanced the patent application, the patent application can be resubmitted to the central system. The date that the patent application was submitted may be time stamped and stored with the file. When the patent application is resubmitted by the attorney, the end user may be notified, such as via an electronic notification. Amendments may be recorded as “change tracking” or stored as a new or associated file.

According to an embodiment, a fee is generated for completed and or enhancing the application, for example, the end user account could be charged the fee, and the attorney and/or the examination office/system account is credited all or a portion of the fee. The system may generate a notice that a fee has been charged and transmits the notice to the end user. The system may further generate a notice that a credit has been applied, and transmit the notice to the attorney or any applicable parties using any suitable means.

According to an embodiment, the end user can then submit the patent application to the central system for a certified prior art search. The request for a certified search is time stamped and stored with the patent application file. The certified prior art search is conducted by the central system and the prior art file is stored with the patent application along with a time /date stamp and other relevant information. When the prior art file is stored with the patent application data, the end user is notified that the certified search is complete via electronic transmission. A fee may be charged to the end user account and a notice of the fee sent to the end user via, for example, electronic transmission.

According to an embodiment, the system could allow end users to embed notes or hyperlinks in a patent application that reference prior art. The examiner can then easily read through an application, checking prior art or notes as he progresses through the document. If there is more than one note or document associated with one or more hyperlinks, any suitable method may be used to provide all the notes and/or documents to the examiner. For example, a pop up window with a listing may appear and allow the user select one, or more, of the notes or documents, such popup window may also includes sort, select or filter options to present a list of notes or documents in a preferred order and/or by including or excluding one or more notes based on any available criteria, including, for example, date, time, alphabetically, relevancy, by provider, end user, or any combination of the forgoing. Alternatively, when a user clicks a link, the most relevant source appears, and a new list appears listing the other remaining documents. Instead, users might have the option to “right click” on the link to see the list and select from that point. Another option provides a different color code depending of whether there is only one or multiple links. In addition to or instead of the color coding, the hyperlink system could automatically insert a super or subscripted number in parentheticals that indicates the number of links, e.g. hyperlink (3).

According to some embodiments, and as described in greater detail herein, an end user can review the prior art file and enter notes to distinguish the patent application over the prior art filed. The notes may be attached to the file and a time stamp generated and stored with the notes and the patent application file along with information about the end user that submitted such notes. Moreover, instead of, or in addition to, time stamping the file, the notes could be date stamped.

According to an embodiment, the system may be configured to track the parts of the patent application that are missing and need to be completed before the patent application can be filed with the patent office. A notice of missing parts can be electronically generated and transmitted to the appropriate end user(s) on a periodic basis or on demand via any applicable means, including via alerts. End users can request sample text for each missing part and/or use a “wizard” that steps them through the process to fill out each section. Once all missing parts have been completed, the end user can submit the patent application to the patent office for examination. The file is time stamped with the date it was submitted to the patent office for examination. A fee may be charged to the end user account to submit the patent application to the patent office. The system may generate a notice that the patent application was submitted and that the appropriate fee charged and send the notice to the appropriate end user(s), for example, via electronic submission.

According to one embodiment, a fee structure that is based on the size, and/or complexity, and/or scope of the application, rather than a fixed fee could be used by the system. For example, fees for patent filings may be based on the number of claims, the number of images, the number of pages of text, or the number of prior art references cited for enablement.

In one example, a system according to the present disclosure may work as follows:

The system selects the appropriate examiner and notifies the examiner that they have a new patent application to examine via electronic transmission. An electronic notice is sent to the end user informing him of the patent examiner assigned to the case and the position in the examination queue of the application. The end user is offered the opportunity to pay to move his patent up in the queue. If the end user accepts, he is given the opportunity to pay for a different position in the examination queue. The end user selects the queue position, and a fee is charged to his account. An electronic notice is transmitted to the end user confirming his position in the queue (and all others currently ahead of him) and the fee charged to his credit card (alternatively the fee could be charged when the patent is examined). The system could notify all end users with patent applications ahead of the patent application in the queue or that otherwise have priority over such application, e.g., based upon demonstrated need or the age of the applicant, giving the end users a “first right of refusal” to maintain their position in the queue. Maintaining such position may or may not require a payment. Such applicants could also appeal to the examiner not to move their application down in the list. U.S. patent application No., 11/611,024, which is hereby incorporated by reference, discloses one applicable method for dealing with items in queue.

Whenever the patent application's position in the examination queue changes, i.e. by being outbid by another end user or when an patent application in the queue ahead of the patent has been examined, the system notifies the end user via electronic transmission that the position in the examination queue of the patent application has changed.

The end user can elect to change the position of the patent application in the examination queue at any time. The system notifies the end user of any changes in the position of the patent application in the examination queue via electronic submission.

When the patent examiner begins his examination of a patent application, an electronic transmission is sent to the end user informing him that the examination has begun. The notice can also include an expected date when the examination will be completed and/or any other relevant or available information, including information such as the examiner's name, qualifications, prior cases, outcome of those cases, etc. Alternatively, the examiner and end users could communicate anonymously with one another during the examination process. All commentary in this embodiment would be time stamped and stored in the file wrapper.

When the examiner completes his examination of a patent, and/or at any other appropriate point, he can submit an office action, that includes, for example, the patent application, the certified search, the distinguishing notes, any additional prior art found by the examiner, and examiner or third party notes questioning or providing evidence against the patentability of the patent application to the central system. The central system stores the office action along with any notes and notifies the end user that the office action has been completed via electronic submission.

An end user can respond to the office action by submitting additional distinguishing notes to the central system. The central system stores the additional distinguishing notes with the patent application.

Patent examiners receiving the patent application, the certified search file, and the distinguishing notes conduct an examination of the patent. Patent Examiners can review the certified search, add prior art documents to the certified search, and add notes to the distinguishing language to argue against the patentability of the patent application. The prior art documents and any notes added by the patent examiner are filed with the central system as an office action on the patent application.

End Users receive notice that an office action has been received for a patent application. End Users can log in to the central system to retrieve the office action document along with any notes or other information. End Users can add notes, argument, and/or additional distinguishing language to the patent application a resubmit the application for a second examination. The central system notifies the patent examiner that the patent application was received for a second examination via electronic notification. The patent application is again placed in the examination queue.

The system also notifies that end user that the patent application was received with such notes, argument and/or additional distinguishing language and the patent application's position in the examination queue.

According to yet another embodiment, when an examiner determines that the claims of a patent application are acceptable, he can provide a notice of allowance to the system. The end user is notified that he has received a notice of allowance and that the patent application is in queue for missing parts and corrections.

The system determines an appropriate draftsperson to review the figures included in the patent application using a method similar to the method it uses to select an examiner for each submitted patent application.

A notification is sent to the draftsperson that a patent application has received a notice of allowance.

The draftsperson reviews the drawings and specifies errors and/or omissions in the drawings that need to be corrected and/or attaches one or more notes. The draftsperson drawing review is submitted to the central system. The central system notifies the end users that the drawings submitted with a patent application have errors and omissions that need to be corrected.

The end user can correct the error and omissions of the drawings submitted with the patent application and resubmit the patent application to the central system. The central system notifies the draftsperson that the errors and omissions to the drawings have been corrected. The draftsperson can then accept the drawing revisions or submit another error and omissions report.

When the drawings are accepted, a notice of allowance is submitted to the end user. A fee may be assessed for issuing the patent and the end user account is charged the fee. A patent number is assigned to the patent application and the patent is issued. A notice is sent to the end user that the patent has been issued.

According to yet another embodiment, the system could notify authorized and/or interested parties that a patent has been issued or an application has been published. End users would only receive such notices on applications and patents in which they have an interest. Interested parties would be given an opportunity to object to any pending or issued patents. Any individual, corporation or other entities (such as potential licensees) can subscribe to the “published and issued patents notification system,” which will send e-mail (or other form of communications, e.g., an alert) to any interested party. When subscribing, subscribers indicate the types of patents, e.g., classes, sub-classes, etc., that they have interest in and/or may do so by indicating or describing the field of use and/or may cite prior art and any applications or issued patents that include such prior art are considered “of interest”. End users could indicate patents applications that they are interested in via check box selection, listing of “similar patents or prior art” which a GA could use to help ID new applications that are “similar” to, e.g., use the “relevancy scoring” process.) Subscribers could indicate the relevancy score above which they have an interest.

According to yet another embodiment, any time an end user or patent examiner logs in to the patent application file, corresponding search file, corresponding distinguishing notes, or other notes, corresponding and certified search, corresponding office action(s), an access and amendment log is created and time stamped. End Users can elect to be notified whenever and by whom the patent application is accessed and or amended and or challenged.

According to another embodiment, potential licensees of the patent application can review the patent application to determine if they want to license the invention. A log is kept of every instance that the patent application was reviewed. A log is also kept of each subsequent patent application where the issued patent application is cited as prior art. Such logs may be generally available, available only to authorized end users, and/or available for a fee, or based upon any other applicable terms and conditions or any combination of the forgoing.

A potential licensee can elect to license the patent. The potential licensee can notify the central system that they would like to license the patent. The central system can notify the end user that an anonymous potential licensee would like to license the patent via electronic transmission. A fee is charged to the potential licensee and the potential licensee is notified that the end user has been notified and a fee has been charged to his account. Such fee may be determined via any applicable means available, including, for example, based upon such factors as: exclusive vs. non-exclusive licenses, term of the license, field of use, novelty score, type of patent, e.g., device vs. method vs. design patents, or based upon input or rules or pricing established by the inventor or her assignee.

The central system can generate an electronic transmission to the potential licensee and the end user to determine if the patent was licensed. If the patent was licensed, the central system records that the patent application was licensed to a particular licensee and the dollar value and other terms and conditions of the license. In some embodiments, the data is kept unpublished, but is used by the central system to determine the strength of the patent application on subsequent prior art and patent strength searches. Potential licensees could be given the opportunity to buy an exclusive or non-exclusive license.

According to some embodiments, serial numbers for patent applications can be assigned in various ways, such as the following:
1. Numbers are assigned by a central system as patent applications are filed
2. Numbers can be distributed in blocks to various sub entities and assigned by the sub entities.
3. Sub entities can request numbers from a central system as end users file patent applications with them.

The class and subclass of a patent application can be generated by the system, assigned by the end user, or assigned by a person in the patent office. If the patent class and subclass are suggested and/or assigned by the system, the system may determine the appropriate class and subclass based on, for example, (i) scanning the text of the patent application and assigning it an appropriate class and subclass based on similar text in patent applications that have already been filed, (ii) asking the end user a series of questions about the application and assigning it a class and subclass based on the answers to the questions (iii) reviewing relevancy scores of included or attached or referenced prior art, or (iv) any combination of the forgoing. An end user could be presented with and select from a suggested class and subclass and or assign a class and subclass to the patent application by answering a series of questions about the application and selecting an appropriate class and subclass based on the answers to the questions.

The system can be built utilizing three different or complementary architectural methods: 1) a simple, table based method 2) a rules based system or 3) an artificial intelligence (A) system such as Neural Net, or Bayesian Algorithm.

Accordingly, the presently described system may incorporate one or more programs or modules configured to perform the various functions described herein. These programs may be housed on one or more servers, including system or client servers. As a non-limiting example, the system may include the following programs housed on the following server:

Central Server
1. Electronic Notification Program
2. Fee Processing Program
3. Status and Content Change Time Stamp Program

The system may further include one or more databases configured to collect and associate various data. Non-limiting examples of databases that would be suitable in the presently described system include:

End User Database
1. End User ID
2. End User Contact Information
3. End User Billing Information

Patent Application Database
1. Application ID
2. End User ID
3. Application Data
4. Application Status
5. Application Score

Patent Examiner Database
1. Examiner ID
2. Examiner Profile
3. Examiner Score

Notification Database
1. Notification ID
2. Notification Descriptor
3. Notification Rules and/or Conditions 1-N
4. Notification Fee

Fee Database
1. Fee ID
2. Fee Descriptor
3. Fee Amount
4. Fee Conditions

Moreover, the system may be configured to perform various method steps such as, but not limited to:

Notify parties of status change of patent application
1. Receive Request to Change Status of Patent Application
2. Change Status of Patent Application and Time Stamp
3. Output notification that status of Patent Application has changed

Charge fees to end users based on status change of patent application
1. Receive indication that status of Patent Application has changed
2. Determine fees for change in status of Patent Application
3. Apply fee to end user account

Add electronic time stamp to changes in status and or content of patent application file wrapper data
1. Receive indication that status and or content of Patent Application has changed
2. Store change in status and/or content of Patent Application Data
3. Time Stamp changes in status and/or content of Patent Application Data

According to yet another embodiment, the present disclosure provides a method and systems to provide undisclosed prior art to invalidate an issued patent and/or one or more of its claims. According to one aspect of this embodiment, after receiving notice from the central notification system, and/or after an end user discovers a pending or issued patent through his own initiative, an end user attaches a prior art file along with any notes to an issued patent application record via a web-based system. The end user requests that the patent be reexamined in light of the prior art file and attached arguments and/or notes. The patent application is flagged as needing reexamination. In an embodiment, a fee is applied to the end user account for submitting the prior art and for requesting the reexamination of the patent application.

The patent application is assigned to an examiner and placed in his examination queue. The patent examiner can reexamine the issued patent application using the prior art submitted by the end user. The patent examiner can also verify that the submitted prior art is legitimate by cross checking the reference and certifying that the prior art reference and date are true and accurate.

The end user who submits the prior art reference and requests the reexamination can be charged a fee when he submits the reference, when the patent is reexamined, or when the patent is or is not invalidated in light of the prior art.

If the issued patent is invalidated in light of the prior art submitted, a refund equal to, less than or greater than the original fee can be given to the end user who submitted the prior art and requested the reexamination of the issued patent. For example, such refund may include the full amount paid, plus interest.

According to some embodiments, the Artificial Intelligence or other search system will also be receiving more prior art files over time. Periodically, the system can reexamine pending and issued patents and add prior art, e.g., prior art with an origin date the precedes the application, to their certified search files, including the insertion of hyperlinks. In the case of pending patents, a notice can be sent to the end user who submitted the patent application that additional prior art has been found and needs to be distinguished over. In the case of issued patents, the system can flag the issued patent as potentially needing to be reexamined (along with a “probability score” and, if the score is above a certain level, place it in an examiner's queue, but not if it has already passed the reexamination process.

According to an embodiment, the artificial intelligence system that conducted the certified search on the patent application can use the added prior art reference as another method of training itself to conduct better searches in the future.

In an embodiment, the A system could automatically check to see if the prior art that was manually submitted to invalidate a patent is in its prior art database but not disclosed. If the prior art is in the database, the A system can certify the validity of the prior art reference before it is reviewed by an examiner. In some embodiments, the system may determine if such manually submitted prior art was submitted by an end user whose prior submissions were found valid or invalid. If prior submissions were found to be invalid, such new submissions may be discounted or be subjected to further review. On the other hand, if such end user's prior submissions were found to be valid, new submissions from such end users may carry more relevancy or the probability score may be increased accordingly. Over time, as end users submit such prior art, their scores or rankings can increase or decrease accordingly, which information can be used by the system to improve its results and/or by patent examiner's in deciding which prior art to consider.

In one or more embodiments, the system could also receive the submission of an expert testimony. For example, in a case where an application makes claims for a step that is clearly obvious to one skilled in the art, but isn't necessarily in the prior art anywhere. Such expert testimony may be provided via any applicable means, including, for example, via notes or alerts.

An alternate embodiment allows end users to submit prior art to a central system and link it to a particular patent application. When an end user submits a piece of prior art, they also indicate the type and/or source of the prior art, i.e. Patent, Lexis Nexus, article, website, etc. The central system verifies that the prior art cited is stored in one of the prior art databases and verifies the prior art date from those databases. In this manner an independent third party system can generally verify the validity and date of prior art cited.

The system can be built utilizing three different architectural methods: 1) a simple, table based method 2) a rules based system or 3) an artificial intelligence (A) system such as Neural Net, or Bayesian Algorithm or any combination of these methods.

Accordingly, the presently described system may incorporate one or more programs or modules configured to perform the various functions described herein. These programs may be housed on one or more servers, including system or client servers. As a non-limiting example, the system may include the following programs housed on the following server:

Central Server
1. Reexamination Program
2. Prior Art Validation Program

The system may further include one or more databases configured to collect and associate various data. Non-limiting examples of databases that would be suitable in the presently described system include:

End User Database
1. End User ID
2. End User Profile
3. End User Billing Information

Prior Art Database
1. Prior Art ID
2. Prior Art Data
3. End User ID
4. Prior Art Submission Date
5. Prior Art Creation Date

Patent Application Database

1. Application ID
2. End User ID
3. Prior Art ID 1-N
4. Prior Art Submitted by 1-N
5. Patent Application Status

Fee Database
1. Fee ID
2. Fee Rules and/or Conditions
3. Fee Amount

Moreover, the system may be configured to perform various method steps such as, but not limited to:

Create Reexamination File
1. Receive request to add a prior art reference to patent application data
2. Store prior art reference with patent application data and time stamp.
3. Flag patent application record as having additional reference and set status for potential reexamination.

Process Reexamination File
1. Output patent application with additional prior art reference
2. Receive reexamination results of patent application
3. Store reexamination results of patent application
4. Output reexamination results of patent application to end user.

Adjust Search Algorithms based on Reexamination file and process
1. Retrieve additional prior art reference and reexamination file
2. Use reference and reexamination file to train genetic algorithm to improve later search results

Validate Prior Art Reference Submitted in Reexamination File
1. Receive a prior art reference to a filed patent application
2. Validate that prior art reference is authentic by finding reference in third party archive
3. Validate creation date of prior art reference by finding creation date of reference in third party archive
4. Flag prior art reference as authentic

In various embodiments, the present disclosure provides systems and methods in which various patent related documents are entered into a system and stored electronically. As described above, in many of these embodiments, end users and patent examiners can access the documents via a web-based or other networked system. Moreover, not only can the documents be reviewed, but notes can be added to them. These notes can be used, for example, to generate relevance scores for prior art documents as they related to submitted patent applications. Accordingly, in one embodiment the present disclosure provides methods and systems for facilitating certified prior art note taking and a method for using the same.

According to various embodiments, notes can be flagged as published or unpublished. According to some embodiments, unpublished notes can be viewed by patent examiners, but not by end users or only by authorized end users. Notes, whether published or not, may be encrypted to better control access by authorized users. The notes could be flagged with several layers of administrative clearance if necessary. Notes may take any suitable form including, but not limited to, blogs, overlays, hyperlinks, threads, or any other method for attaching or embedding words, comments, documents, or the like, into a digital document. For example, the end user and/or examiner could add notes that appear as a rollover overlay to a section of a patent application. However attached, according to one embodiment, the notes will be associated with the patent application so that they can be partially or completely viewed simultaneously with the patent application. For the purposes of the present disclosure, a note may be viewed “simultaneously” whenever the note, a portion thereof, or a link thereto, can be viewed at the same time as a portion of the patent application. According to various embodiments, such simultaneous viewing should be available with a minimal amount of effort by the viewer. For example, the viewer may be required to roll their cursor over a portion of the patent application in order to view some or all of the note or a link thereto. However, in this embodiment, a viewer should not be required to separately search for and download the note.

According to some embodiments, some, or all, of the prior art identified or referred to by the notes may be hosted by the system. Alternatively, some or all of the prior art may reside in or on other systems (e.g., electronic documents available through the library of Congress). Accordingly, a link in a note may or may not lead to a document hosted on the same server as the patent submission system described herein.

According to some embodiments, examiners or other users may be able to highlight sections of prior art with different colors. The different colors may be ranked to indicate various factors such as, but not limited to, the degree of relevance and/or the degree of potential infringement. The end user and/or examiner could then add feedback to indicate whether the art was flagged with the appropriate highlight color.

The system can be built utilizing three different architectural methods: 1) a simple, table based method 2) a rules based system or 3) an artificial intelligence (AI) system such as Neural Net, or Bayesian Algorithm.

Accordingly, a system such as that described herein may be configured to perform the various functions described above and may incorporate one or more servers capable of running any number and/or combination of software modules configured to perform various tasks. Exemplary combinations of servers and software modules useful for the presently-described system include:

Central Server
1. Note Addition Program
2. Note Review Program

A system according to the present disclosure may further include a number of databases configured to store and associate the various types of data that are used by the system to perform the functions described above. Exemplary database architectures useful for the presently-described system include:

Prior Art Database
1. Prior Art Type
2. Prior Art ID
3. Prior Art Date
4. Prior Art Data
5. Note 1-N
6. End User ID

Note Database
1. Note Type
2. Note ID
3. Note Date
4. End User ID
5. Prior Art 1-N

End User Database
1. End User Type
2. End User ID
3. End User Profile
4. End User Billing Information

Accordingly, a system such as that described herein will be configured to perform various functions, such as those described above, by performing various method steps in order to accomplish one or more given tasks. Non-limiting examples of methods that may be performed by a system according to the present disclosure include the following:

Add Certified Note to Prior Art File
1. Retrieve Prior Art File
2. Output Prior Art File
3. Receive Note for Prior Art File and Note Type
4. Attach Note and Note Type to Prior Art File
5. Store Prior Art File with Note
6. Time Stamp date when Note was Added to Prior Art File

Review Certified Note Attached to Prior Art File

1. Retrieve Prior Art File with attached Note

2. Determine Note Type

3. Determine End User Type

4. If End User Type matches Note Type, Output Prior Art File with Attached Note

The invention is described with reference to several embodiments. However, the invention is not limited to the embodiments disclosed, and those of ordinary skill in the art will recognize that the invention is readily applicable to many other diverse embodiments and applications. Accordingly, the subject matter of the present disclosure includes all novel and nonobvious combinations and subcombinations of the various systems, methods and configurations, and other features, functions, and/or properties disclosed herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing an automated patent submission system configured to:
receive a patent application;
store the patent application in electronic form;
receive an electronic transmission containing a note from an entity regarding the patent application;
associate the note with the patent application;
displaying the patent application; and
displaying the note simultaneously with the patent application.

2. The method of claim 1 wherein the note comprises material selected from the group consisting of: the text of one or more prior art references and a hyperlink to the text of one or more prior art references.

3. The method of claim 1 further comprising displaying the note as hyperlinked text in the patent application.

4. The method of claim 1 further comprising displaying the note in a pop-up window when a viewer moves a cursor over a portion of the patent application.

5. The method of claim 1 further comprising displaying the note in a sidebar adjacent to the patent application.

6. The method of claim 1 wherein the note is automatically displayed with the patent application.

7. The method of claim 1 further comprising receiving a request from a viewer to view one or more notes.

8. The method of claim 7 further comprising determining if the viewer is entitled to view a note.

9. The method of claim 8 further comprising determining that the viewer is entitled to view a note if the viewer is an examiner.

10. The method of claim 8 wherein determining if the viewer is entitled to view the note comprises determining if the note comprises material that is not otherwise publicly available.

11. The method of claim 10 wherein the note comprises material that is selected from the group consisting of: one or more unpublished patent applications and a hyperlink to one or more unpublished patent applications.

12. The method of claim 1 wherein the note includes visible indicia configured to indicate the relevance of the note to the patent application with which it is associated.

13. The method of claim 1 wherein the visible indicia is color coded highlighting.

14. A system comprising:
a database of patent applications;
a database of notes, wherein each note is associated with at least one patent application;
a patent application display interface configured to simultaneously display a patent application from the database of patent applications and the notes associated with the patent application.

15. The system of claim 14 further comprising a security mechanism configured to identify a viewer attempting to access the notes associated with a patent application.

16. The system of claim 15 further comprising a user interface configured to:
receive notes from one or more entities; and
store the notes in the database.

17. The system of claim 14 wherein the notes comprise the text of prior art documents.

18. The system of claim 14 wherein the notes comprise hyperlinks to prior art documents.

19. The system of claim 14 wherein the notes comprise commentary regarding the relevance of prior art documents.

20. The system of claim 19 wherein the commentary is displayed in the form of color-coding of the note.
